(19) United States
(12) Patent Application Publication
(10) Pub. No.: US 2014/0258819 A1
(43) Pub. Date: Sep. 11, 2014

(54) Information Servicing Method and System

(71) Applicant: Fonestock Technology Inc., Taipei (TW)

(72) Inventors: Chu Tsung Chen, Taipei (TW); Jun Yih Lee, Taipei (TW); Kuan Hao Huang, Taipei (TW)

(73) Assignee: FONESTOCK TECHNOLOGY INC., Taipei (TW)

(21) Appl. No.: 14/195,431

(22) Filed: Mar. 3, 2014

(30) Foreign Application Priority Data
Mar. 5, 2013 (TW) 102107656

(51) Int. Cl. G06F 17/22

(52) U.S. Cl. CPC G06F 17/2235
USPC 715/205

(57) ABSTRACT

An information servicing method and an accompanying system use the VPN wireless communication channel of information service provider to transmit pure text contents of each information record to corresponding user devices, and use another wireless communication channel to transmit multimedia contents contained in the information record to the user devices; such that usage of communication bandwidth of the VPN wireless communication channel can be substantially minimized and the cost thereof can also be reduced. The information service provider includes a server which analyzes each information record in advance to obtain a goods symbol corresponding to the information record. The user device generates a chart by using the received goods symbol and its corresponding information record. The chart and the pure text content of the information record are integrated into a single page which is then actively displayed on the display of the user device.

### BACKGROUND OF INVENTION

1. Field of the Invention

The invention relates to an information servicing method and an associated system for the method, and more particularly to the method and the system that introduce a wireless communication channel to transmit pure text contents of an information record and another wireless communication channel to transmit multimedia contents of the same information record. Thereby, the communication bandwidth for transmitting the pure text contents can be substantially reduced.

2. Description of the Prior Art

In the era of information technology, transmission through wireless communications meets a blooming need at both ends of the receiving and the transmitting. Traffic jams in bandwidthing for the wireless communications become severe day by day. For those information service providers, besides the work in providing sufficient amounts and plenty kinds of information, the concerns of transmission quality and timing reality are topics worthy to be further devoted to.

For example, to an information service provider in stocks and securities, majority of its client ends are portable electronic devices such as stock phones, PDAs and/or smart phones to connect, in a VPN manner, with the corresponding servers at the provider end for information exchanging/uploading/downloading, through feasible mobile communication network such as, but not limited to, GSM850/900/1800/1900, CDMA, WCDMA, PHS, GPRS, WiMAX, LTE and so on. For information contents of securities (or say, negotiable securities) may affect directly timing and accuracy in clients' performing investments on the related securities. Hence, it is crucial in business competition for information service providers whether the client-concerned information can be rapidly, preferably in real time, provided to the clients' portable electronic devices. Sometimes, these information contents include memory-occupant multimedia such as, but not limited to, photos, cartoons, video data, and so on. However, the bandwidth of the wireless communication for the VPN that is utilized by the information service provider to transmit data is limited, and usually proportionally with the communication cost. Therefore, to avoid traffic jams of the communication bandwidth for the VPN while still providing real-time information and keeping low communication cost, the information service provider for the securities used to trim down the memory-occupant multimedia contents from the whole information contents, and leave only the pure-text contents for being transmitted to the client-end portable electronic devices. Upon such an arrangement, the clients can only receive and browse the pure-text contents of the information, while the multimedia contents are already abandoned at the provider end.

Furthermore, while the securities information is forwarded to the portable electronic devices from the information service provider, it is usually the case that the portable electronic devices can display only the securities information itself, particularly only the pure-text contents thereof. If the client is interested in some detail information related to the displayed securities, he/she might need to have his/her portable electronic device to switch the original page (showing the pure-text contents) to some other pages that may demonstrate possible selections for browsing such detail information. For example, in the case that the displayed information contents are related to news information regarding real-time price fluctuations of a specific stock, if the client wants to understand the real-time trading trend of the specific stock, he/she needs to end the browsing operation of the news information in advance, and then he/she go ahead to choose a new page that displays the real-time trading trend of the specific stock. Obviously, such an operation for getting data of the trading trend is definitely cumbersome in practice.

### SUMMARY OF THE INVENTION

Accordingly, it is the primary object of the present invention to provide an information servicing method and a system for performing the same, both of which can use the VPN wireless communication channel (the first wireless communication channel) of information service provider to transmit pure text contents of each information record to corresponding user devices, and use another wireless communication channel (the second wireless communication channel) to transmit multimedia contents contained in the information record to the user devices. Thereupon, usage of communication bandwidths of the VPN wireless communication channels can be substantially minimized and the cost thereof can also be reduced. Thereby, providing of the information can be executed both in much real-timely and more rapidly,

It is another object of the present invention to provide an information servicing method and a system for performing the same, in both of which the information service provider can have its own servers to analyze in advance each of information records so as to obtain a goods symbol corresponding to the information record. In the case that the pure-text contents of any information record are to be wireless-transmitted through the VPN to the user devices, the goods symbol is also modulated in the transmission signals. The user devices can then judge the merchandise details according to the received goods symbol. The user device generates a chart by using the received goods symbol and its corresponding information record. The chart and the pure-text contents of the information record are integrated into a single page which is then actively displayed on the display of the corresponding user device. Upon such an arrangement, the user can browse the pure-text contents and the chart of the specific information record simultaneously at the same page, without any further operation in switching the display page at the user device.

Accordingly, in the present invention, an information servicing method is provided to an information servicing system having at least a user device, a database and a server connected with the database. The information servicing method includes the steps of:

Step (A): the server captures at least an information record from a foreign information source;

Step (B): the server analyzes the information record and obtains therefrom a headline, a pure-text content and a hyperlink;

Step (C): the server stores at least the headline, the pure-text content and the hyperlink into the database in a correlation manner;

Step (D): the server pushes at least the headline to at least one user device, through a wireless communication medium, so as to display the headline on the at least one user device; and

Step (E): the server uses the wireless communication medium to receive a headline selection signal from the user device, and thereby the pure-text content and the hyperlink related to the headline corresponding to the headline selection signal are forwarded to the user device through the same wireless communication medium.

To achieve the aforesaid purposes, an accompanying information servicing system of the present invention comprises:

at least one user device;

a database; and

a server, connected with the database, in which the server can capture at least one information record from a foreign information source, further can analyze the captured information record so as to obtain at least one headline, a pure-text content and a hyperlink related to the information record, and can store the at least one headline, the pure-text contend and the hyperlink into the database in a correlation manner.

In the present invention, the server can use a wireless communication medium to push at least the headline to at least one user device for being further displayed thereon, the user device can issue a headline selection signal upon an operation of selecting the headline by one user, then the server can forward the pure-text content and the hyperlink related to the headline selection signal to the user device through the same wireless communication medium for further displaying at the user device while the server receives the headline selection signal from the user device through the wireless communication medium, the user device can issue a hyperlink selection signal while an operation of selecting the hyperlink is made by one user, and then a web page corresponding to the hyperlink related to the hyperlink selection signal received from the user device can be transmitted from the server to the user device through the wireless communication medium so as to be further displayed at the user device.

In one embodiment of the present invention, the headline selection signal is generated in accordance with a user action at the user device to click the headline, and after the foregoing step (E) the user device accounts for the headline selection signal to display the pure-text content and the hyperlink related to the headline. Then, the user device can issue a hyperlink selection signal while an operation of selecting/clicking the hyperlink is made by one user, and thereafter a web page corresponding to the hyperlink related to the hyperlink selection signal received from the user device can be transmitted from the server to the user device through the wireless communication medium so as to be further displayed at the user device.

In one embodiment of the present invention, the wireless communication medium can further include at least a first wireless communication channel and a second wireless communication channel; in which the server uses the first wireless communication channel to push the headline to the user devices, the individual user device uses the first wireless communication channel to forward the headline selection signal to the server, the server uses also the first wireless communication channel to transmit the pure-text content and the hyperlink to the user devices, but the user device uses the second communication channel to capture the concerned web page.

In one embodiment of the present invention, the web page includes at least the complete content of the information record. The information record includes at least one of the following multimedia data: a drawing data, a cartoon data and a video data; in which the drawing data, the cartoon data and the video data can be only transmitted to the user device through the second wireless communication channel, not the first wireless communication channel, upon meeting the hyperlink selection signal. It is defined that the first wireless communication channel is used to push or transmit data in a pure-text form such as the headline, the pure-text content and the hyperlink. In the present invention, the first wireless communication channel is a wireless communication channel of a VPN (Virtual private network), and the second wireless communication channel is also a wireless communication channel BUT NOT belonged to the same VPN including the first wireless communication channel.

In one embodiment of the present invention, the server in the aforesaid step (B) can further obtain a corresponding goods symbol while in analyzing the information record. Thereby, in the following step (C), the server can store the goods symbol, the headline, the pure-text content and the hyperlink into the database in a correlation manner. In the present invention, the goods symbol is in a form of pure text. Accordingly, in step (E), as soon as the server receives the headline selection signal, the server would use the wireless communication medium to transmit the goods symbol, along with the pure-text content and the hyperlink related to the headline corresponding to the headline selection signal, to the user device. Thereafter, the user device would generate a chart in accordance with the received goods symbol, and then the chart, the pure-text content and the hyperlink of the information record are integrated into a single page to be displayed at the corresponding user device.

In one embodiment of the present invention, the information record is a news record related to the securities. The wireless communication medium includes at least one of a mobile telecommunication medium and a wireless network communication medium. The operation of the server capturing at least one information record from the information source is in a form of really simple syndication (RSS).

Accordingly, an information servicing method of the present invention, applicable to an information servicing system including at least one user device, a database and a server connected with the database, comprises the steps of:

Step (a): the server captures at least an information record from a foreign information source, in which the information record includes at least one multimedia selected from the group of a drawing data, a cartoon data and a video data;

Step (b): the server analyzes the information record and obtains therefrom a headline, a pure-text content and a hyperlink;

Step (c): the server stores at least the headline, the pure-text content and the hyperlink into the database in a correlation manner;

Step (d): the user device uses a first wireless communication channel to receive at least the headline, the pure-text content and the hyperlink from the server so as to display the headline, the pure-text content and the hyperlink at the user device; and

Step (e): while the user device meets a hyperlink selection signal generated by a user clicking/selecting the hyperlink, the user device uses a second wireless communication channel to capture a web page corresponding to the hyperlink and further to display the web page at the user device; in which the web page includes at least the whole contents of the information record having the multimedia. In particular, in the present invention, the multimedia, either the drawing data, the cartoon data or the video data, can be transmitted through the second wireless communication channel only upon meeting the hyperlink selection signal. Also, importantly, the transmission of such multimedia in accordance with the present invention can only performed through the second wireless transmission channel, and would never be performed through the aforesaid first wireless communication channel or any other channels. (It is noted that the first wireless communication channel is used to push or transmit data in a pure-text form such as the headline, the pure-text content and the hyperlink.

All these objects are achieved by the information servicing method and system described below.

### BRIEF DESCRIPTION OF THE DRAWINGS

The present invention will now be specified with reference to its preferred embodiment illustrated in the drawings, in which:

FIG. 1 is a schematic illustration of an embodiment of the information servicing system in accordance with the present invention;

FIG. 2A illustrates a display of an embodiment of the information servicing system in accordance with the present invention, in which the headline, the chart, the pure-text content and the hyperlink are integrated into a unique page at the user device;

FIG. 2B shows an embodiment of the user device of the information servicing system in accordance with the present invention, in which a web page is shown in this user device;

FIG. 3 is a flowchart for operation of a server of an embodiment of the information servicing method in accordance with the present invention;

FIG. 4 is a flowchart for operation of a user device of an embodiment of the information servicing method in accordance with the present invention;

FIG. 5 is a block diagram showing schematically an embodiment of the headline pushing structure of the information servicing system in accordance with the present invention;

FIG. 6 is a block diagram to illustrate the operation of capturing the information and pushing the headline in the information servicing system of FIG. 5, and

FIG. 7 is a block diagram to illustrate the operation of selecting/clicking the headline in the information servicing system of FIG. 5.

### DESCRIPTION OF THE PREFERRED EMBODIMENT

The invention disclosed herein is directed to an information servicing system and an accompanying method for performing the same. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In accordance with the present invention, the information servicing method and system can utilize the wireless communication channel (i.e., the first wireless communication channel) of the virtual private network (VPN) belonged to the information service provider for data transmission to transmit each of the pure-text data of the corresponding information record to the respective user device, while the multimedia data of the same information record is transmitted through another wireless communication channel (i.e., the second wireless communication channel) to the same user device. Upon such arrangement, the advantages in reducing the communication bandwidths of the VPN and the associated transmission cost can be comprehensively achieved. Further, in the present invention, the server of the information service provider can analyze each of the information records in advance so as to extract a corresponding goods symbol from individual information record. Then, the user device can generate a chart related to the information record according to the received goods symbol. In particular, the chart and the aforesaid pure-text data are integrated into the same display page on the screen of the user device.

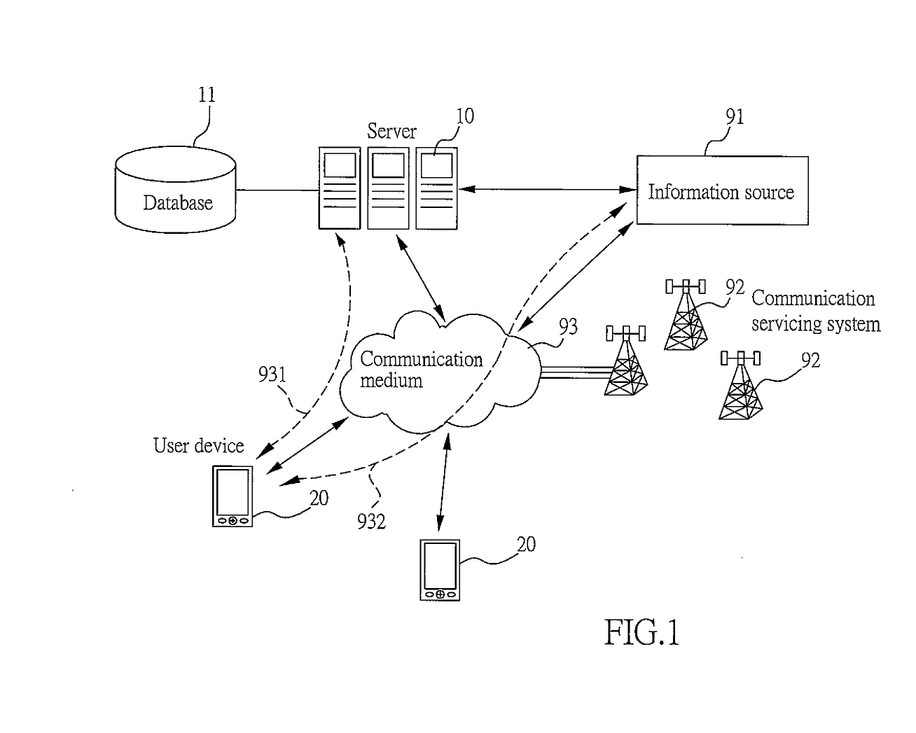

Referring now to FIG. 1, an embodiment of the information servicing system in accordance with the present invention is schematically shown. It is noted that the information servicing method in accordance with the present invention is to be carried out in the information servicing system like the one shown in FIG. 1. As illustrated, the information servicing system includes at least one user device 20, a database (DB) 11 and a server 10 connected with the database 11. The user device 20, the server 10 and an information source 91 are network-integrated through a wireless communication medium 93 provided by at least one communication servicing system 92. In this embodiment, the information servicing system is to provide information service of securities including, but not limited to, stocks, futures, warrants, funds, bonds and so on. The information source 91 as a location where the server 10 and the user device 20 can capture the required information records can be, but not limited to, a stock exchange, a securities firm, a bank, a news media, a TV company, a broadcaster, or any private company that provides real-time or historic databases. The communication servicing system 92 can be, but not limited to, a GSM850/900/1800/1900 system, a CDMA system, a WCDMA system, a PHS system, a GPRS system, a WiMAX system, an LTE system and so on. The user device 20 can be, but not limited to, a portable electronic device such as a stock information receiver, a PDA, a smart phone and so on. The information record can be a news information related to securities. The wireless communication medium 93 can include at least one of a mobile telecommunication medium and a wireless network communication medium.

In this embodiment shown in FIG. 1, the server 10 can capture at least an information record from the foreign information source 91 via the wireless communication medium 93 or any other appropriate communication medium (for example, but not limited to, a cable network, an internet, or a wire connection with a neighboring network terminal). The captured information record is further analyzed so as to obtain therefrom at least a serial number, a headline, a pure-text content, a hyperlink and a goods symbol corresponding to the information record. The serial number, the headline, the pure-text content, the hyperlink and the goods symbol are then stored into the database 11 in a correlation manner. In the present invention, the goods symbol is in a pure-text format. Thereafter, the server 10 can go through the first wireless communication channel 931 of the wireless communication medium 93 to push at least the headline and the serial number of the information record to at least one user device 20 for being displayed at the screen of the corresponding user device 20. If any of the users is interested in the displaying headline, he/she can work on the corresponding user device 20 by clicking or selecting the headline or the serial number so as to generate a corresponding headline selection signal, which is then further forwarded to the server 10. When the server 10 receives the headline selection signal from the user device 20 through the first wireless communication channel 931 of the wireless communication medium 93, the server 10 would use the first wireless communication channel 931 of the wireless communication medium 93 to transmit the pure-text content, the hyperlink and the goods symbol related to the headline corresponding to the headline selection signal to the user device 20. Thereby, the user device 20 can display the pure-text content and the hyperlink related to the headline corresponding to the headline selection signal on its own screen. At the same time, the user device 20 can generate a chart in accordance with the received goods symbol, and then the chart associated with the pure-text content and the hyperlink are integrated into a single page to be displayed at the corresponding user device 20. It is noted that at this time the goods symbol is not demonstrated.

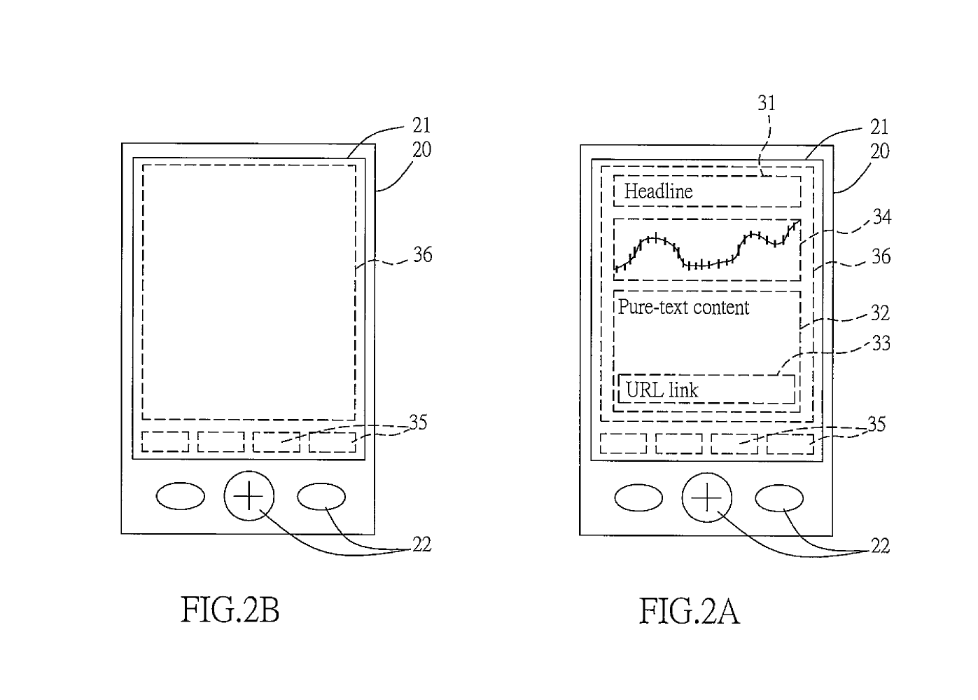

Referring now to FIG. 2A, a display of an embodiment of the information servicing system in accordance with the present invention is schematically demonstrated, in which the headline, the chart, the pure-text content and the hyperlink are integrated into a unique page at the user device. The user device 20 has a screen 21 and at least one solid button 22 (three shown in the figure). In this embodiment, after the user device 20 integrates the chart, the related pure-text content and the related hyperlink into the same page, the screen 21 of the user device 20 would present a headline column 31, a pure-text content column 32, a chart column 34 and a plurality of virtual function keys 35. In the headline column 31, the headline and the serial number of the information record are shown. In the pure-text content column 32, the pure-text content of the information record is demonstrated, and in particular at least one hyperlink 33 (URL connection) can be also included. The chart column 34 is used to contain the chart. The plurality of virtual function keys 35 is furnished for users to operate the user device 20 or to perform application programs of the information servicing method in accordance with the present invention on the user device 20. In one embodiment of the present invention, the user device 20 can judge the goods symbol to identify the corresponding merchandise content and further to generate the chart related to the merchandise content. In particular, the chart and the pure-text data of the information record are integrated into the same display page of the screen 21 of the user device 20. For example, when the information content is related to news information regarding real-time fluctuation of quotes on a specific stock, the server 10 would generate a goods symbol (a number or a text expression) in correspondence to the text of “trading flow of the specific stock”, while in analyzing the information record. Thereby, while the user device 20 displays the pure-text content of the information record, the trading flow of the specific stock would be automatically shown in the same page. Therefore, the user can browse simultaneously the pure-text content of the information record and the related chart, without any further operation or page switching on the user device 20. Thereupon, the disadvantage in lousy operations on the conventional user device 20 for viewing the chart is thus improved. In the present invention, for the chart is generated by the user device 20 by accounting to the pure-text goods symbol, transmission of the chart through the wireless communication medium 93 is no more needed, and so is the transmission bandwidth. In one embodiment of the present invention, the user device 20 generates the chart by according to the pure-text goods symbol to sort the existing data in the user device 20. In another embodiment, the user device 20 generates the chart by firstly according to the pure-text goods symbol, then capturing the pure-text data corresponding to the goods symbol from the server 10 via the first wireless communication channel 931, and finally sorting the captured data to formulate the chart at the user device 20.

In this embodiment as shown in FIG. 2A, the hyperlink 33, generated by the server 10 while in analyzing the information record, is respective to at least one multimedia originally included in the information record, such as (but not limited to) a drawing data, a cartoon data, a video data and so on. For all the aforesaid multimedia would not be transmitted to the user device 20 at this stage, the information servicing method of the present invention introduces alternatively the transmission of the hyperlink to make notice the user that the information record includes multimedia materials not shown in this pure-text display. Hence, if the information record does not contain any multimedia material and is just a pure-text record, then the pure-text content thereof would not include the hyperlink. As shown, the hyperlink 33 is embodied as a selectable function block in the screen 21 of the user device 10. In the function block, the displayed text can be, but not limited to, “Complete reading”, “Detail content”, “Illustrations”, “Videos”, “Hyperlink”, or the URL Web address of the Hyperlink. When the function block of the hyperlink 33 is clicked/selected, the user device 20 would ride a second wireless communication channel 932 of the wireless communication medium 93 to the URL website of the Hyperlink for capturing directly the corresponding web page. In this embodiment, the URL website is the website of the information source 91, not that of the server 10. Also, the web page includes at least the whole content of the information record.

When the user device 20 displays the integrated pure-text content of the information record (in which the pure-text content contains at least one hyperlink 33, the user can get ahead to perform the clicking/selection upon the hyperlink 33 as long as he/she is interested in the web page or multimedia corresponding to the hyperlink 33. In response to the clicking/selection operation upon the hyperlink 33, the user device 20 would generate a corresponding hyperlink selection signal for having the user device 20 to capture the web page related to the hyperlink from the server 10 via the second wireless communication channel 932 of the wireless communication medium 93 and further to display the captured web page on the user device 20.

Referring now to FIG. 2B, a display arrangement of an embodiment of the information servicing system in accordance with the present invention is shown, in which the headline, the chart, the pure-text content and the hyperlink are integrated into a unique page at the user device. As shown, the screen 21 of the user device 20 includes a web page column 36 and a plurality of virtual function key columns 35. In this embodiment, the web page captured from the server 10 through the second wireless communication channel 932 of the wireless communication medium 93 can be filled into the web page column 36.

In the present invention, the wireless communication medium 93 provided by the information servicing system includes at least one first wireless communication channel 931 and one second wireless communication channel 932. The server 10 can utilize the first wireless communication channel 931 to push the headline to the user device 20. The user device 20 can use the first wireless communication channel 931 to forward the headline selection signal to the server 10. The server 10 can apply the first wireless communication channel 931 to transmit the pure-text content and the hyperlink to the user device 20. Particularly, the user device 20 picks the second wireless communication channel 932 to capture the web page from the server 10. Namely, in response to the hyperlink selection signal, multimedia contents of the drawing data, the cartoon data and/or the video data in the information record can only be transmitted from the server 10 to the user device 20 via the second wireless communication channel 932, not and never via the first wireless communication channel 931. Furthermore, it is noted that those materials of the information record (including the serial number, the headline, the pure-text content, the hyperlink and the goods symbol) transmitted through the first wireless communication channel 931 are all in the form of pure text, and therefore occupy only limited transmission capacity. In this embodiment, the first wireless communication channel 931 is a wireless communication channel of a virtual private network (VPN) furnished by the information service provider (i.e., the so-called inner net), while the second wireless communication channel 932 is not a VPN, but is another paid wireless communication channel to the user device 20 (i.e., the so-called outer net). For the transmission of the captured web page from the server 10 to the user device 20 is to go through the second wireless communication channel 932, not the first wireless communication channel 931 of the server 10, so such a transmission would not occupy any bandwidth of the first wireless communication channel 931 between the user device 20 and the server 10. Hence, merits in both saving the communication bandwidth of the VPN and reducing the communication cost can be obtained. Also, for the bandwidth is sufficient, the transmission in between can be more rapid and more efficiency.

In one embodiment of the present invention, a single SIM card can be provided to the user device 20, and according to the SIM card the user device 20 can initiate both the first wireless communication channel 931 (the inner net, a VPN furnished by the information service provider) and the second wireless communication channel 932 (the outer net, a wireless communication channel furnished by the communication servicing system). When application programs of the information servicing method of the present invention are executed, the user device 20 is to use the first wireless communication channel 931 to connect with the server 10 and to access the information services provided by the server 10. In the case that the hyperlink 33 is clicked/selected, the user device 20 would go to the second wireless communication channel 932 for capturing the web page or multimedia data from the server 10. If the user device 20 doesn't perform the application programs of the information servicing method of the present invention but performs the other network functions (for example, but not limited to, internet browsing through a browser, running network games, downloading through internets and so on), the second wireless communication channel 932 is utilized to carry out the networking and the data transmission, at which the first wireless communication channel 931 is idle without connection with the server for the application programs of the information servicing method of the present invention are not executed herein. In addition, when the user device 20 is equipped with auto-switch ability between the mobile communication transmission and the WiFi transmission, the user device 20 would use automatically the WiFi channel as the second wireless communication channel 932 if the WiFi connection is feasible.

In another embodiment of the present invention, the user device 20 may carry two SIM cards; one (the first SIM card) for activating the first wireless communication channel 931 (the so-called inner net, a VPN furnished by the information service provider), and another (the second SIM card) for activating the second wireless communication channel 932 (the so-called outer net, a wireless communication channel furnished by the communication servicing system). When the application programs of the information servicing method of the present invention are executed, the user device 20 is to use the first SIM card to activate the first wireless communication channel 931 to connect with the server 10 and to access the information services provided by the server 10. When the aforesaid hyperlink 33 is clicked/selected, the user device 20 would use the second SIM card automatically to activate the second wireless communication channel 932 to capture the web page or multimedia data from the server 10.

In the same embodiment, when the user device 20 captures the web page including the multimedia data via the second wireless communication channel 932, the web page would be firstly transformed into an appropriate display format for the application programs of the information servicing method of the present invention before it can be displayed on the screen 21 of the user device 20. Namely, according to the present invention, the user device 20 can display the captured web page under the same application programs, without an additional step of performing or switching to perform some other programs. In a further embodiment of the present invention, after the user device 20 captures the web page including the multimedia data via the second wireless communication channel 932, a browser program would be executed to display the captured web page. Hence, in this embodiment, the user needs to perform switching operations between the original application programs and the browser program so as to obtain relevant pages and functions for displaying the multimedia data of the web page.

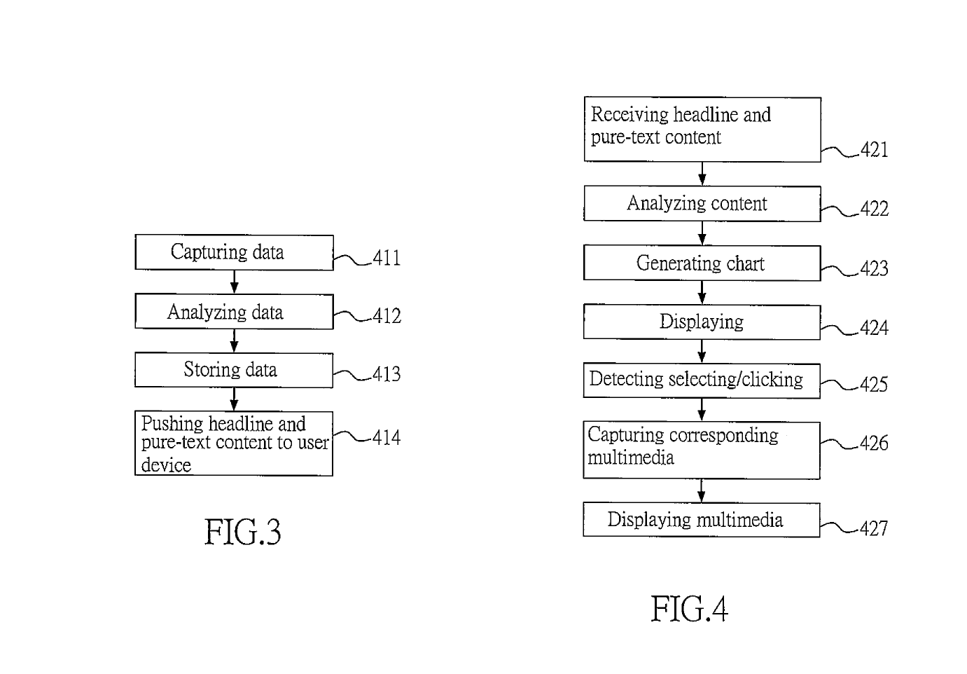

Referring now to FIG. 3, a flowchart for operations of a server of an embodiment of the information servicing method in accordance with the present invention is shown. In the information servicing method of the present invention, steps for the server 10 includes:

Step 411: the server capturing at least an information record from a foreign information source;

Step 412: the server analyzing the information record and obtaining therefrom a serial number, a headline, a pure-text content, a hyperlink and a goods symbol, in which the hyperlink may be none if the information record contains only the pure-text content and does not include any multimedia data (i.e., the hyperlink space would be filled with a “0” or an “NA” after analyzing the information record);

Step 413: the server storing at least the serial number, the headline, the pure-text content and the hyperlink into the database in a correlation manner; and

Step 414: the server pushing at least the serial number and the headline to at least one user device, through a wireless communication medium (the first wireless communication channel), so as to display the serial number and the headline on the at least one user device; then, the server using the same wireless communication medium (the first wireless communication channel) to receive a headline selection signal from the user device, and thereby the pure-text content, the hyperlink and the goods symbol related to the headline corresponding to the headline selection signal being forwarded to the user device through the wireless communication medium.

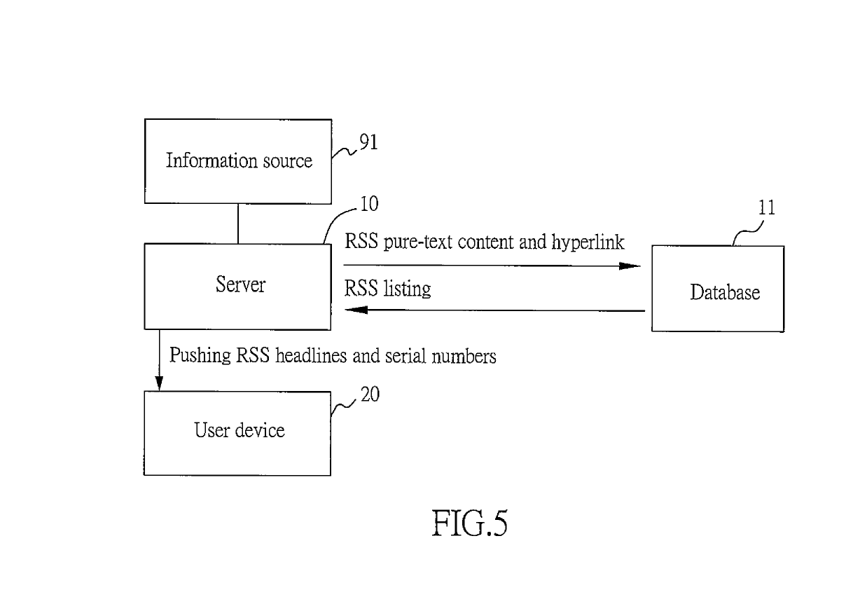

Referring now to FIG. 4, a flowchart for operation of a user device of an embodiment of the information servicing method in accordance with the present invention is shown. In the information servicing method of the present invention, steps for the user device 20 includes:

Step 421: the user device using a wireless communication medium (the first wireless communication channel) to receive and display at least the serial number and the headline from the server; when the serial number or the headline is clicked/selected by a user, the user device generating the headline selection signal in response to the aforesaid user action and forwarding the headline selection signal to the server via the wireless communication medium (the first wireless communication channel); and then, the user device receiving the pure-text content, the hyperlink and the goods symbol related to the headline corresponding to the headline selection signal via the same wireless communication medium (the first wireless communication channel);

Step 422: the user device analyzing the received pure-text content, headline and goods symbol;

Step 423 : the user device generating a chart according to the goods symbol;

Step 424: the user device integrating the pure-text content, the hyperlink and the chart into a unique page and display the page on the screen;

Step 425: when the user device detects a click/selection operation upon the hyperlink by a user, the user device generating a hyperlink selection signal and realizing a corresponding URL address related to the hyperlink selection signal;

Step 426: the user device using a second wireless communication channel to connect the URL address corresponding to the selected hyperlink and capturing web page or multimedia data therefrom; and

Step 427: the user device displaying the captured web page or multimedia data on the screen.

Referring now to FIG. 5, a block diagram showing schematically an embodiment of the headline pushing structure of the information servicing system in accordance with the present invention is shown. In this embodiment, the executing of the server capturing at least one information record from the information source is in a form of really simple syndication (RSS). After the server captures the information record from the information source, the RSS pure-text content and the hyperlink listing would be stored into the database. According to an RSS forward listing stored in the database, the server pushes the RSS headline and serial number to plural subscribed user devices.

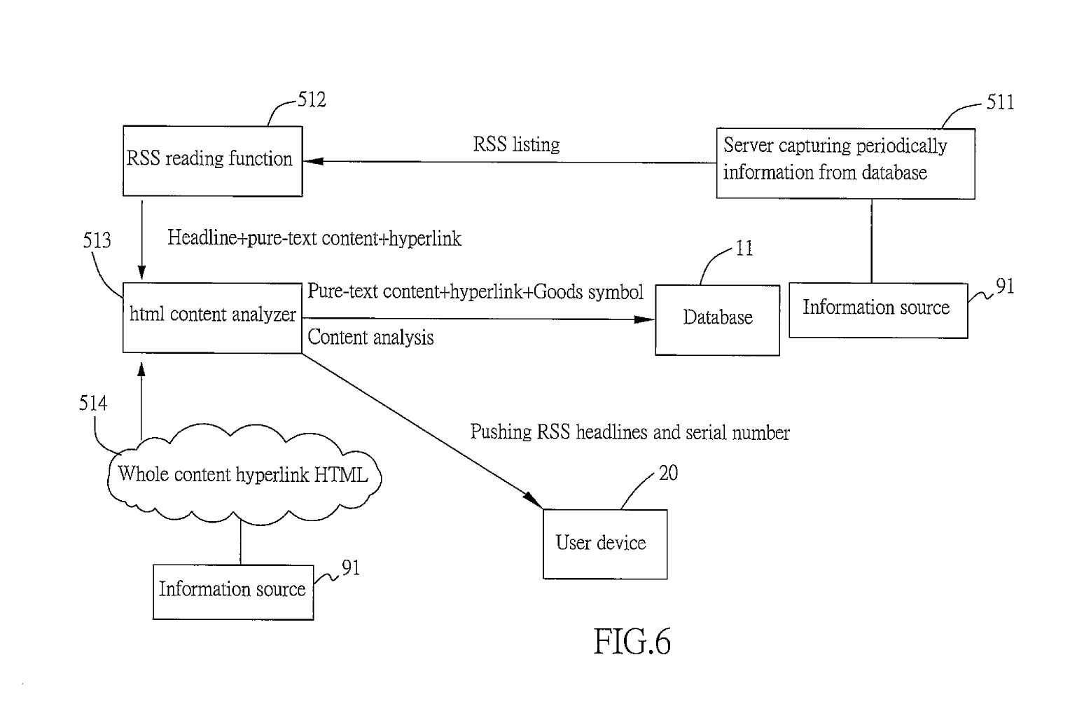

Referring now to FIG. 6, a block diagram to illustrate the operation of capturing the information and pushing the headline in the information servicing system of FIG. 5 is shown. In block 511, the server periodically captures at least one information record from the information source, and generates a corresponding RSS forward listing. In block 512, an RSS reading function of the server reads the RSS forward listing and the at least one information record, and generates a serial number, a headline, a pure-text content, a hyperlink and a goods symbol with respect to each captured information record. In block 513, an HTML content analyzer of the server go through a whole content hyperlink HTML (block 514) to capture candidate web page data which might include the required multimedia data from the information source, and receives the serial number, the headline, the pure-text content, the hyperlink and the goods symbol with respect to the at least one information record from the RSS reading function of the server. In block 513, the server performs a content analysis upon the at least one information record, stores the serial number, the headline, the pure-text content, the hyperlink and the goods symbol with respect to the at least one information record into the database, and also pushes the headline and the serial number with respect to the at least one information record to plural subscribed user devices.

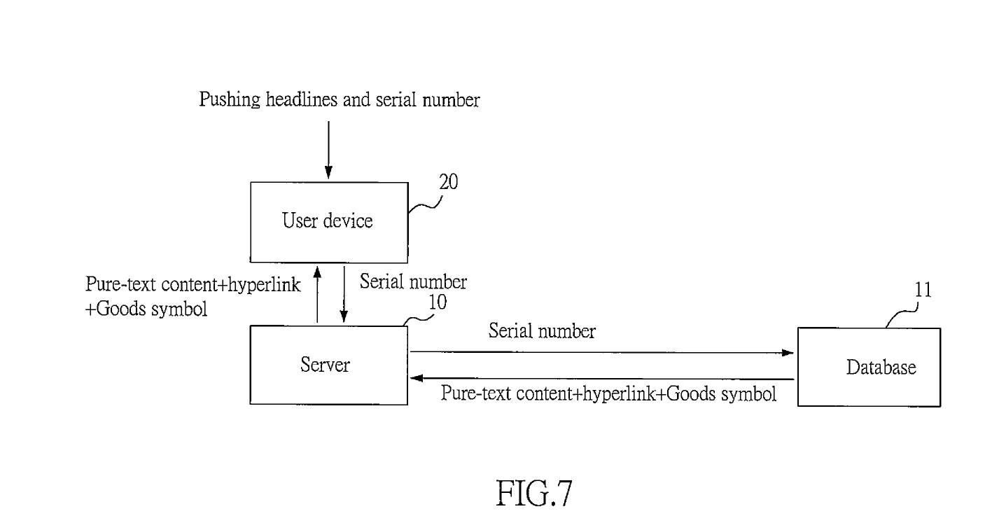

Referring now to FIG. 7, a block diagram to illustrate the operation of selecting/clicking the headline in the information servicing system of FIG. 5 is shown. In this embodiment, the user device receives and displays the headline and the serial number received from the server. If the user device detects a click/selection operation upon the headline or the serial number by a user, the user device would generate and forward a corresponding headline selection signal to the server, in which the headline selection signal includes preferably the serial number. Then, according to the serial number contained in the headline selection signal, the server would locate the corresponding pure-text content, hyperlink and goods symbol in the database. Thereafter, the server would transmit the corresponding pure-text content, hyperlink and goods symbol related to the information record to the user device for further displaying thereon.

While the present invention has been particularly shown and described with reference to a preferred embodiment, it will be understood by those skilled in the art that various changes in form and detail may be without departing from the spirit and scope of the present invention.

What is claimed is:

1. An information servicing method, applicable to an information servicing system having at least a user device, a database and a server connected with the database, comprising the steps of:
Step (A): the server capturing at least an information record from a foreign information source;
Step (B): the server analyzing the information record and obtaining therefrom a headline, a pure-text content and a hyperlink;
Step (C): the server storing at least the headline, the pure-text content and the hyperlink into the database in a correlation manner;
Step (D): the server pushing at least the headline to at least one user device, through a wireless communication medium, so as to display the headline on the at least one user device; and
Step (E): the server using the wireless communication medium to receive a headline selection signal from the user device, and thereby the pure-text content and the hyperlink related to the headline corresponding to the headline selection signal being forwarded to the user device through the wireless communication medium.

2. The information servicing method according to claim 1, wherein the headline selection signal is generated in accordance with a user action at the user device to click the headline; after the Step (E), the user device accounts for the headline selection signal to display the pure-text content and the hyperlink related to the headline; then, the user device issues a hyperlink selection signal while an operation of selecting/clicking the hyperlink is made by one user at the user device; and, thereafter, the user device transmits the hyperlink selection signal to the server through the wireless communication medium and captures a web page corresponding to the hyperlink from the server also through the wireless communication medium so as to be further displayed at the user device.

3. The information servicing method according to claim 2, wherein the wireless communication medium further includes at least a first wireless communication channel and a second wireless communication channel; in which the server uses the first wireless communication channel to push the headline to the user device, the individual user device uses the first wireless communication channel to forward the headline selection signal to the server, the server uses also the first wireless communication channel to transmit the pure-text content and the hyperlink to the user device, but the user device uses the second communication channel to capture the web page.

4. The information servicing method according to claim 3, wherein the web page includes at least a whole content of the information record, wherein the information record includes at least one of the following multimedia data: a drawing data, a cartoon data and a video data, wherein the drawing data, the cartoon data and the video data are transmitted to the user device only through the second wireless communication channel, not the first wireless communication channel, upon meeting the hyperlink selection signal, wherein the first wireless communication channel is used to push or transmit data in a pure-text form such as the headline, the pure-text content and the hyperlink, wherein the first wireless communication channel is a wireless communication channel of a virtual private network (VPN) while the second wireless communication channel is another wireless communication channel NOT belonged to the VPN.

5. The information servicing method according to claim 1, wherein the server in the Step (B) further obtains a corresponding goods symbol while in analyzing the information record, wherein in the Step (C) the goods symbol in a form of pure text, the headline, the pure-text content and the hyperlink are stored into the database in a correlation manner, wherein in the Step (E), as the server receives the headline selection signal, the server uses the wireless communication medium to transmit the goods symbol along with the pure-text content and the hyperlink related to the headline corresponding to the headline selection signal to the user device, wherein thereafter the user device generates a chart in accordance with the received goods symbol and then the chart, the pure-text content and the hyperlink of the information record are integrated into a single page to be displayed at the corresponding user device.

6. The information servicing method according to claim 5, wherein the information record is a news record related to securities, wherein the wireless communication medium includes at least one of a mobile telecommunication medium and a wireless network communication medium, wherein that the server captures at least one information record from the information source is in a form of really simple syndication (RSS).

7. An information servicing system, comprising:
at least one user device;
a database; and
a server, connected with the database, capturing at least an information record from a foreign information source, analyzing the information record and obtaining therefrom a headline, a pure-text content and a hyperlink, further storing at least the headline, the pure-text content and the hyperlink into the database in a correlation manner;
wherein the server pushes at least the headline to the at least one user device, through a wireless communication medium, so as to display the headline on the at least one user device; the user device responds a user action of clicking the headline at the user device by generating the headline selection signal; the server uses the wireless communication medium to receive the headline selection signal from the user device and thereby the pure-text content and the hyperlink related to the headline corresponding to the headline selection signal are forwarded to the user device through the wireless communication medium; the user device issues a hyperlink selection signal while an operation of selecting/clicking the hyperlink is made by one user at the user device; and, the user device transmits the hyperlink selection signal to the server through the wireless communication medium and captures a web page corresponding to the hyperlink from the server also through the wireless communication medium so as to be further displayed at the user device.

8. The information servicing system according to claim 7, wherein the wireless communication medium further includes at least a first wireless communication channel and a second wireless communication channel; in which the server uses the first wireless communication channel to push the headline to the user device, the individual user device uses the first wireless communication channel to forward the headline selection signal to the server, the server uses also the first wireless communication channel to transmit the pure-text content and the hyperlink to the user device, but the user device uses the second communication channel to capture the web page.

9. The information servicing system according to claim 8, wherein the web page includes at least a whole content of the information record, wherein the information record includes at least one of the following multimedia data: a drawing data, a cartoon data and a video data, wherein the drawing data, the cartoon data and the video data are transmitted to the user device only through the second wireless communication channel, not the first wireless communication channel, upon meeting the hyperlink selection signal, wherein the first wireless communication channel is used to push or transmit data in a pure-text form such as the headline, the pure-text content and the hyperlink, wherein the first wireless communication channel is a wireless communication channel of a virtual private network (VPN) while the second wireless communication channel is another wireless communication channel NOT belonged to the VPN.

10. The information servicing system according to claim 7, wherein the server further obtains a corresponding goods symbol while in analyzing the information record, wherein the goods symbol in a form of pure text, the headline, the pure-text content and the hyperlink are stored into the database in a correlation manner, wherein, as the server receives the headline selection signal, the server uses the wireless communication medium to transmit the goods symbol along with the pure-text content and the hyperlink related to the headline corresponding to the headline selection signal to the user device, wherein thereafter the user device generates a chart in accordance with the received goods symbol and then the chart, the pure-text content and the hyperlink of the information record are integrated into a single page to be displayed at the corresponding user device.

11. The information servicing system according to claim 10, wherein the information record is a news record related to securities, wherein the wireless communication medium includes at least one of a mobile telecommunication medium and a wireless network communication medium, wherein that the server captures at least one information record from the information source is in a form of really simple syndication (RSS).

12. An information servicing method, applicable to an information servicing system having at least a user device, a database and a server connected with the database, comprising the steps of:
Step (a): the server capturing at least an information record from a foreign information source, wherein the information record includes at least one of the following multimedia data: a drawing data, a cartoon data and a video data;
Step (b): the server analyzing the information record and obtaining therefrom a headline, a pure-text content and a hyperlink;
Step (c): the server storing at least the headline, the pure-text content and the hyperlink into the database in a correlation manner;
Step (d): the user device using a first wireless communication channel to receive at least the headline, the pure-text content and the hyperlink from the server so as to display the headline, the pure-text content and the hyperlink at the user device; and
Step (e): while the user device meets a hyperlink selection signal generated by a user clicking/selecting the hyperlink, the user device using a second wireless communication channel to capture a web page corresponding to the hyperlink and further to display the web page at the user device, wherein the web page includes at least a whole content of the information record having the multimedia, wherein the multimedia, either the drawing data, the cartoon data or the video data, is transmitted only through the second wireless communication channel (never through the first wireless communication channel) upon meeting the hyperlink selection signal, noted wherein the first wireless communication channel is used to push or transmit data in a pure-text form such as the headline, the pure-text content and the hyperlink.

13. The information servicing method according to claim 12, wherein the Step (d) further includes the steps of:
Step (d1): the server pushing at least the headline to the at least one user device, through the first wireless communication channel, so as to display the headline on the at least one user device;
Step (d2): the server using the wireless communication medium to receive a headline selection signal from the user device, and the pure-text content and the hyperlink related to the headline corresponding to the headline selection signal being forwarded to the user device through the first wireless communication channel, wherein the headline selection signal is generated by the user device while in responding a user action of clicking the headline; and
Step (d3): the user device displaying the pure-text content and the hyperlink related to the headline corresponding to the headline selection signal.

14. The information servicing method according to claim 13, wherein in the Step (b) further obtains a corresponding goods symbol while in analyzing the information record, wherein in the Step (c) the goods symbol in a form of pure text, the headline, the pure-text content and the hyperlink are stored into the database in a correlation manner, wherein in the Step (d2), as the server receives the headline selection signal, the server uses the wireless communication medium to transmit the goods symbol along with the pure-text content and the hyperlink related to the headline corresponding to the headline selection signal to the user device, wherein thereafter the user device generates a chart in accordance with the received goods symbol and then the chart, the pure-text content and the hyperlink of the information record are integrated into a single page to be displayed at the corresponding user device; wherein the first wireless communication channel is a wireless communication channel of a virtual private network (VPN) while the second wireless communication channel is another wireless communication channel NOT belonged to the VPN.

15. The information servicing method according to claim 14, wherein the information record is a news record related to securities, wherein each of the first wireless communication channel and the second wireless communication channel includes at least one of a mobile telecommunication medium and a wireless network communication medium, wherein that the server captures at least one information record from the information source is in a form of really simple syndication (RSS).
